(19) United States
(12) Patent Application Publication
(10) Pub. No.: US 2024/0056806 A1
(43) Pub. Date: Feb. 15, 2024

(54) DEVICE AUTHORIZATION IN AN ENTERPRISE NETWORK BASED ON WHETHER A MOBILE NUMBER IS IN A USER INFORMATION REPOSITORY

(71) Applicant: HEWLETT PACKARD ENTERPRISE DEVELOPMENT LP, Houston, TX (US)

(72) Inventor: Antoni Milton, Santa Clara, CA (US)

(21) Appl. No.: 17/819,434

(22) Filed: Aug. 12, 2022

(51) Int. Cl. H04W 12/06; H04W 12/72; H04L 9/40

(52) U.S. Cl. CPC H04W 12/06; H04W 12/72; H04L 63/0892

(57) ABSTRACT

In some examples, a system of an enterprise network sends, in response to a request for authentication transmitted in response to a request by an electronic device to access the enterprise network, an authentication request from the system to a server that is part of a carrier network. The system receives, in response to the authentication request, an authentication response that contains a value representing a mobile number for the electronic device, and checks whether the mobile number represented by the value in the authentication response is present in a user information repository. The system performs authorization of the electronic device based on the check of whether the mobile number represented by the value in the authentication response is present in the user information repository, the authorization for the electronic device to determine an access permission of the electronic device in the enterprise network.

### BACKGROUND

An enterprise network can be a secure network that allows authorized electronic devices to access resources on the network, while unauthorized electronic devices are not allowed access to resources on the network. In some cases, role-based authorization can be performed in which an electronic device can be allowed access to a subset of resources on the network based on a role of a user associated with the electronic device. Resources can include information (such as information stored in data repositories), communication resources (e.g., subnets of the enterprise network, virtual networks, etc.), program resources (e.g., application programs running on application servers, web programs running on web servers, etc.), storage resources (e.g., storage subsystems that can be used by users to store data), and so forth.

### BRIEF DESCRIPTION OF THE DRAWINGS

Some implementations of the present disclosure are described with respect to the following figures.

FIG. 1 is a block diagram of an arrangement that includes an enterprise authentication and authorization server, user information repositories, and a service provider authentication and authorization server, according to some examples.

FIG. 2 is a message flow diagram of a process involving various entities, including those depicted in FIG. 1, according to some examples.

FIG. 3 is a block diagram of a storage medium storing machine-readable instructions according to some examples.

FIG. 4 is a block diagram of a server according to some examples.

FIG. 5 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

An enterprise network can refer to a network associated with an enterprise such as a business concern, a government agency, an educational organization, an individual, or any other entity. The enterprise may specify policies that govern permissions of users in accessing resources on the enterprise network. The resources on the enterprise network can include any or some combination of the following: information in information repositories (e.g., databases, log files, webpages, etc.), communication resources, processing resources, storage resources, and so forth.

Generally, an “enterprise network” can refer to any network associated with an entity that can control or specify permissions for access of the network. For example, the enterprise network may be behind a firewall or be otherwise protected by a security mechanism that prevents unauthorized users from accessing the network.

In some examples, role-based access of resources on the enterprise network can be defined. Users can have different roles in the enterprise. For example, there may be different types of employees of the enterprise, with some employees having greater permissions to access resources on the enterprise network than other employees. For example, a first employee may have an executive office role, which provides the first employee with permissions to access more resources on the enterprise network than a second employee with a different role (e.g., sales role, technical support role, etc.).

The enterprise may also retain contractors that may be granted permissions to access resources on the enterprise network to perform the tasks of the contractors. In further examples, the enterprise may allow guests (visitors) of the enterprise to have restricted access to the enterprise network, such as to give the guests wireless access so the guests can communicate over a public network such as the Internet. Typically, except to allow wireless access to communicate over a public network, guests are not granted access to other resources on the enterprise network.

Employees and contractors of the enterprise may be considered “regular users” of the enterprise network, which are users that access the enterprise network to perform tasks on a frequent or repeated basis. On the other hand, guests are “irregular users” of the enterprise network in that the guests do not normally access the enterprise network, but may occasionally visit the enterprise such that the guest would like to access the enterprise network on a restricted basis.

More generally, various different types of users may have different relationships to the enterprise (e.g., a business concern, a government agency, an educational organization, an individual, etc.) and who may be provided with different permissions with respect to access of the enterprise network.

In some cases, an enterprise may allow users (regular users or guests) to bring their own devices. Bring your own device (BYOD) refers to a policy of permitting users of the enterprise to bring electronic devices that are personally owned by the users (rather than electronic devices owned by the enterprise). Examples of electronic devices can include any or some combination of the following: smartphones, tablet computers, notebook computers, desktop computers, and/or other electronic devices.

In some examples, before personal electronic devices can be allowed access of an enterprise network, the personal electronic devices are first onboarded. Onboarding an electronic device can refer to configuring the electronic device to allow the electronic device to perform an onboarding procedure, which can include any or some combination of the following: downloading an onboarding application program to the electronic device to initiate the onboarding procedure, performing the onboarding procedure to download a digital certificate to the electronic device (where the digital certificate is used by the electronic device to access the enterprise network), establishing a username and password, and/or other onboarding tasks.

Onboarding procedures can be cumbersome and time consuming as they may involve a number of actions on the part of users. For example, the user may have to download an onboarding application program to the user's electronic device, initiate an onboarding procedure where the user may be asked for various pieces of information about the user, setup usernames and passwords, and other actions.

In accordance with some implementations of the present disclosure, authorized access to an enterprise network that includes a wireless network by a user's electronic device (e.g., the user's personal electronic device) can be granted without the user having to initiate and be involved in performing various tasks of an onboarding procedure, which may be cumbersome and inconvenient to the user.

In some examples, an electronic device is authorized in the enterprise network without performing onboarding of the electronic device in the enterprise network by first authenticating the electronic device based on sending, from a first server in the enterprise network, an authentication request to a second server in a carrier network. In response to the authentication request, the second server in the carrier network sends, to the first server in the enterprise network, an authentication response that includes a value representing a mobile number of the electronic device. The first server authorizes the electronic device in the enterprise network (e.g., a role-based authorization or another type of authorization) based on checking whether the mobile number included in the authentication response is present in a user information repository.

Note that the term “user information repository” can refer to a single user information repository or multiple user information repositories.

A “carrier network” can refer to a network that allows electronic devices that have subscribed to a service of a service provider to connect to and communicate over the carrier network. A ‘service provider’ of a carrier network refers to an entity that manages operations of the carrier network.

In some examples, a carrier network can include a mobile communications network that has a wireless access network that allows electronic devices to maintain wireless connections with the wireless access network while the electronic devices move across different locations within a coverage area of the wireless access network.

A “mobile number” for an electronic device can refer to an identification value that can be associated with the electronic device and that is used to contact the electronic device wherever the electronic device is attached to the wireless access network. For example, the electronic device may be a mobile device that can move to different geographic locations, and in some cases can wirelessly connect to any of various carrier networks and/or enterprise networks at the different geographic locations. At any point of attachment, the electronic device can use the mobile number to identify itself when communicating with other devices. In an example, a mobile number can include a phone number that can be assigned to the electronic device, such as based on a subscription by a user of the electronic device with a service provider (e.g., a service provider of a carrier network).

A specific example of a mobile number is a Mobile Station International Subscriber Directory Number (MSISDN). Other examples of mobile numbers can be used in other implementations, where the mobile numbers can have a specified format as defined by standards, open-source specifications, and so forth.

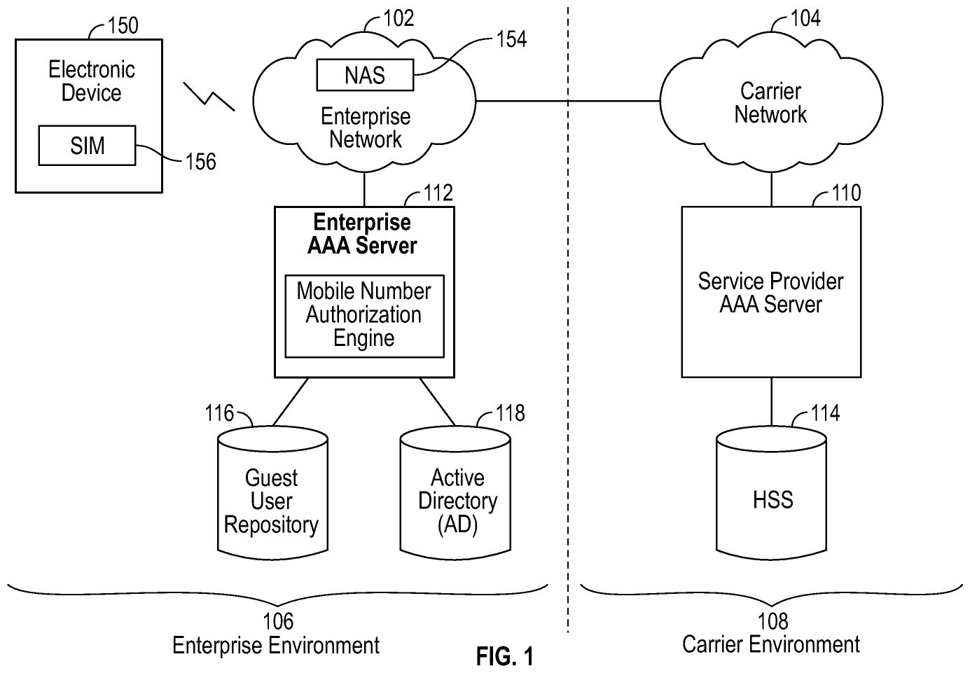

FIG. 1 is a block diagram of an example arrangement that includes an enterprise network 102 and a carrier network 104. The enterprise network 102 is part of an enterprise environment 106 that can be secured against unauthorized access by users not authorized to access resources on the enterprise network 102. As an example, the enterprise environment 106 includes infrastructure components of an enterprise to support communications over the enterprise network 102, including components to authenticate and authorize electronic devices for access of resources on the enterprise network 102.

The carrier network 104 is part of a carrier environment 108 that includes infrastructure components to support communications over the carrier network 104, including components to authenticate and authorize electronic devices for access of resources on the carrier network 104. Electronic devices authorized to access the carrier network 104 can include electronic devices associated with users who have subscribed with a service provider of the carrier network 104, for example.

In some examples, the enterprise network 102 includes a wireless local area network (WLAN), also referred to as a WI-FI network. The WLAN can include access points (APs) that electronic devices, including an electronic device 150 shown in FIG. 1, can wirelessly connect to.

In some examples, the carrier network 104 includes a mobile communications network, which can include base stations that electronic devices can wirelessly connect to when the electronic devices are in coverage areas of the base stations.

The carrier environment 108 includes a service provider authentication, authorization, and accounting (AAA) server 110. In some examples, the authentication and authorization server 110 can perform authentication, authorization, and accounting tasks according to standards of the Third Generation Partnership Project (3GPP). 3GPP defines protocols for mobile communications, including Fourth Generation (4G) mobile communications protocols, Fifth Generation (5G) mobile communications protocols, and so forth.

Generally, the service provider AAA server 110 can perform authentications of electronic devices (e.g., to verify the identities of users or electronic devices). An authentication of an electronic device can be based on a credential associated with the electronic device. The credential can be matched to information in a database, and if a match is found, authentication succeeds; otherwise, authentication fails and network access is denied.

Following authentication, the electronic device obtains authorization from the service provider AAA server 110 for doing certain tasks. An authorization process can enforce policies to determine whether actions requested by the electronic device is allowed.

The service provider AAA server 110 can also perform accounting tasks that keeps track of activities of a user or electronic device in accessing network resources, including the amount of time spent connected to the network, the resources accessed while connected to the network, and the amount of data transferred. Accounting can be used for billing, capacity planning, auditing, cost allocation, and so forth.

The enterprise environment 106 includes an enterprise AAA server 112 that is separate and distinct from the service provider AAA server 110 in the carrier environment 108. The service provider AAA server 110 is operated by a service provider of the carrier environment 108, whereas the enterprise AAA server 112 is operated by an enterprise that operates the enterprise environment 106. The enterprise AAA server 112 can perform authentication, authorization, and accounting tasks in the enterprise environment 106.

Although FIG. 1 shows an example in which AAA servers are used, in other examples, other types of authentication and authorization servers can be employed for authenticating electronic devices and authorizing the electronic devices to perform activities in a network. Such authentication and authorization servers can operate according to standards, open-source specifications, or proprietary protocols.

The carrier environment 108 includes a subscriber database that contains information of subscribers of the carrier network 104. In some examples, the subscriber database is in the form of a Home Subscriber Server (HSS) 114. The HSS 114 stores subscriber information that includes information of the subscribers of the carrier network 104, as well as permissions associated with the subscribers in the use of the carrier network 104. The service provider AAA server 110 can use the HSS 114 to verify whether a request from an electronic device to access the carrier network 104 should be granted or denied. Although reference is made to an HSS in some examples, other types of subscriber databases can be employed in other examples.

In accordance with some implementations of the present disclosure, the enterprise environment 106 further includes user information repositories that store information of users that have registered with the enterprise. The user information repositories include a guest user repository 116 and an active directory (AD) 118.

The guest user repository 116 includes information of guests that have registered with the enterprise. The AD 118 can include information of regular users (e.g., employees, contractors, etc.) of the enterprise. An AD 118 is an example of an enterprise user repository that includes information of regular users. User information in either the guest user repository 116 or the AD 118 can be used, such as by the enterprise AAA server 112, to determine whether or not electronic devices are allowed access of the enterprise network 102.

User information can be added to each of the guest user repository 116 and the AD 118 based on registrations by users. A “registration” of a user with the enterprise can refer to any action by which the user submits information of the user to the enterprise. For example, a guest may provide information to lobby personnel or security personnel of the enterprise when checking in as part of a visit to the facilities of the enterprise. As another example, an employee or contractor or other regular user may submit information as part of filling out paperwork to allow the employee or contractor or other regular user access to facilities of the enterprise.

The registration of a user with an enterprise can be performed by filling in paper forms, filling information in an online portal, or by any other technique.

The user information included in each of the guest user repository 116 and the AD 118 can include various different pieces of information. In some examples of the present disclosure, one of the pieces of information that can be included in the guest user repository 116 and the AD 118 for each respective user is the mobile numbers of the respective user. The mobile number (e.g., MSISDN) may be supplied by the user when registering with the enterprise. For example, as part of registration, the enterprise can ask for contact information of the user, where the contact information sought can include the user's mobile number as well as other information, such as an email address, a home address, and so forth.

Although FIG. 1 shows two different user information repositories (116 and 118), one for guests and the other for regular users, in other examples, a single user information repository can be used to store both guest user information and regular user information.

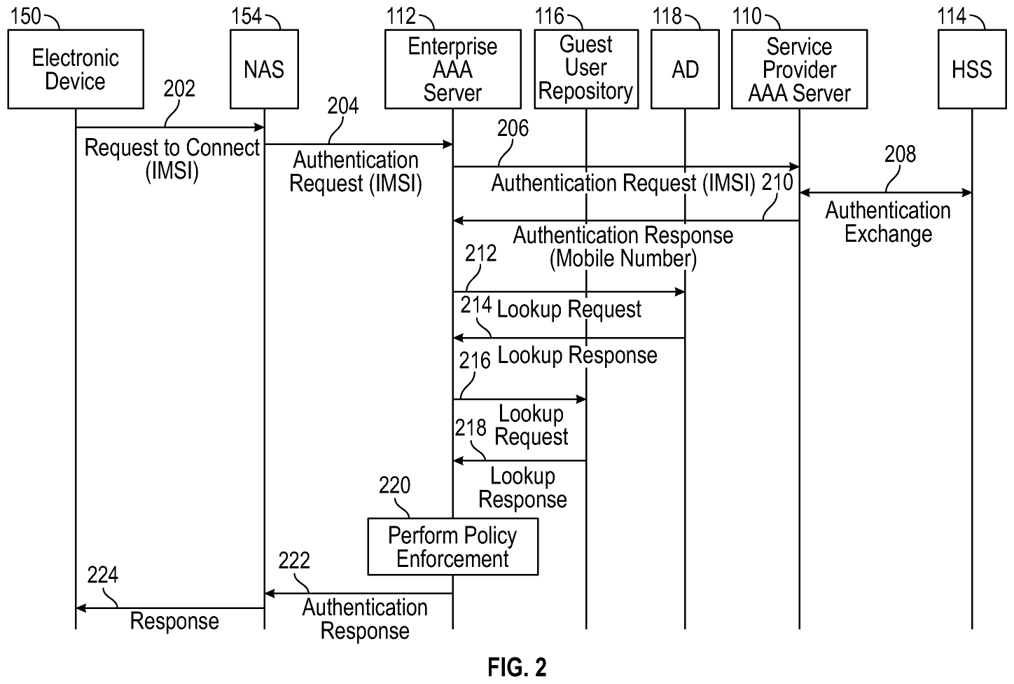

Referring further to FIG. 2, a message flow diagram is shown of an example process performed by the electronic device 150, a network access server (NAS) 154 (FIG. 1), the enterprise AAA server 112, the service provider AAA server 110, and the HSS 114. In different examples, a sequence of tasks different from those shown in FIG. 2 can be performed.

In the example of FIG. 2, the electronic device 150 sends (at 202) a request to connect to the enterprise network 102. The electronic device 150 may be a guest's personal electronic device or a regular user's personal electronic device, for example.

The electronic device 150 includes a Subscriber Identity Module (SIM) 156 (FIG. 1), which stores information that can be used to associate the electronic device 150 with a subscriber account associated with a user of the electronic device 150. Among the information stored in the SIM 152 is an International Mobile Subscriber Identity (IMSI), which can be used to identify and authenticate a subscriber (in this case the user of the electronic device 150). In some examples, the SIM 152 is a physical SIM card that is removably installed in the electronic device 150. Alternatively, the SIM 152 can be implemented using an embedded SIM (eSIM) in the form of machine-readable instructions, which can be executed on a chip (e.g., a universal integrated circuit card (UICC) chip) that is part of the electronic device 150.

The request to connect sent at 202 can include the IMSI (among other information) from the SIM 152. The request to connect that includes the IMSI from the electronic device 150 can trigger a SIM-based authentication of the electronic device 150 by the enterprise network 102.

Specifically, the request to connect from the electronic device 150 is received by the NAS 154. The NAS 154 is an example of an access control point for electronic devices that wish to connect to the enterprise network 102. An access control point can initiate an authentication and authorization process to determine whether or not a requesting electronic device is permitted to access a network such as the enterprise network 102, and if so, what permissions for access of resources on the network are granted.

For example, in response to the request to connect from the electronic device 150, the NAS 154 sends (at 204) an authentication request to the enterprise AAA server 112. In some examples, the authentication request is a SIM-based authentication request that uses the information stored in the SIM 152 (FIG. 1) for authenticating the electronic device 100. The authentication request sent at 204 by the NAS 154 to the enterprise AAA server 112 can include the IMSI received by the NAS 154 from the electronic device 150.

A more specific example of an authentication request is set forth below:

Authentication Request(EAP-SIM, AKA, AKA′).

In the foregoing example authentication request, EAP stands for Extensible Authentication Protocol. EAP-SIM refers to an EAP mechanism for authentication using information of the SIM 156, including the IMSI and other information. EAP-SIM uses a SIM authentication algorithm between a client (in this case the electronic device 100) and an AAA server (in this case the enterprise AAA server 112).

AKA stands for Authentication and Key Agreement, which refers to a process to perform authentication and establishment of one or more security keys for cryptographic protection of information communicated over a wireless network (in this case the enterprise network 102). AKA can provide for larger authentication keys and supports signaling and data encryption to enhance security.

AKA′ (or AKA Prime) is a modified version of AKA that enables access to wireless networks such as WLANs (or equivalently, WI-FI networks) or other types of wireless networks.

In examples according to FIG. 2, the authentication request is according to the Remote Authentication Dial-in User Service (RADIUS) protocol that can be used to perform authentication, authorization, and accounting management for users who are attempting to connect and use a network service.

Although a specific example of an authentication request is discussed above, it is noted that in other examples, an authentication request sent by an access control point to an authentication and authorization server can be a different type of authentication request, such as an authentication request according to non-3GPP protocols, including open-source protocols, proprietary protocols, so forth.

In response to the authentication request received from the NAS 154, the enterprise AAA server 112 sends (at 206) a corresponding authentication request (containing the IMSI and other information from the electronic device 150) to the service provider AAA server 110. In some examples, the enterprise AAA server 112 can merely forward the authentication request received from the NAS 154 to the service provider AAA server 110. In such examples, the authentication request from the enterprise AAA server 112 to the service provider AAA server 110 can also be a RADIUS authentication request.

In other examples, the enterprise AAA server 112 can encapsulate or otherwise convert the received authentication request to a format according to an authentication protocol used between the enterprise AAA server 112 and the service provider AAA server 110.

In response to the authentication request from the enterprise AAA server 112, the service provider AAA server 110 performs (at 208) an authentication exchange with the HSS 114. In some examples, the authentication exchange can be according to the DIAMETER protocol, which can be used for determining services that a user can access, a quality of service (QoS) to be provided for the service access, a cost associated with the access of the service, and so forth. The DIAMETER protocol specifies the messages and information elements of the messages that are employed to obtain the information from the HSS 114.

The HSS 114 can include multiple entries for corresponding different users. Each entry of the HSS 114 can associate a respective user (subscriber) by IMSI with information pertaining to service(s) that the user can access, the QoS of the service(s), and costs of the service(s), and so forth. In addition to the foregoing information, each entry of the HSS 114 associated with a respective user can include a mobile number (e.g., MS ISDN) for the respective user. Although specific types of information are listed above, in other examples, entries of the HSS 114 (or more generally a subscriber database of the carrier environment 108) can include alternative or additional information.

In other examples, another protocol governing access of a subscriber database can be employed by the service provider AAA server 110.

The authentication exchange (208) between the service provider AAA server 110 and the HSS 114 includes a request message (containing the IMSI from the electronic device 150 and other information) sent by the service provider AAA server 110 to the HSS 114.

In response to the request message, the HSS 114 determines whether an entry exists for the IMSI, and if so, retrieves the entry from the HSS 114. The retrieved entry of the HSS 114 contains a mobile number for the electronic device 150, in addition to other information as noted above. The information in the identified entry of the HSS 114 is sent by the HSS 114 to the service provider AAA server 110 in a response message of the authentication exchange 208.

In response to the response message from the HSS 114, the service provider AAA server 110 sends (at 210) an authentication response to the enterprise AAA server 112 (e.g., according to the RADIUS protocol). The authentication response can include an accept or reject indication. The accept indication is included in the authentication response if an entry in the HSS 114 was found for the electronic device 150, such as based on the IMSI. The reject indication is included in the authentication response if no entry was found in the HSS 114 for the IMSI.

In accordance some implementations of the present disclosure, the authentication response sent by the service provider AAA server 110 to the enterprise AAA server 112 contains the mobile number, such as the MSISDN, provided by the HSS 114. The mobile number can be included in an information element of a message that contains the authentication response.

In response to receiving the mobile number, the enterprise AAA server 112 sends (at 212) a lookup request to the AD 118. Although the example of FIG. 2 depicts use of the AD 118, in other examples, another type of enterprise user repository can be used instead. The lookup request contains the mobile number received from the service provider AAA server 110. If the user of the electronic device 150 is a regular user that had previously registered with the enterprise, then the AD 118 would contain an entry for the user.

In response to the lookup request, if the AD 118 determines if an entry of the AD 118 contains the mobile number in the lookup request. If so, the AD 118 returns (at 214) a lookup response that contains information in the identified entry of the AD 118. This information in the identified entry is returned (at 214) in a lookup response from the AD 118 to the enterprise AAA server 112.

In some examples, the lookup response from the AD 118 can include group information relating to the user of the electronic device 115. For example, the group information can identify a group that the user belongs to, such as a marketing group, an engineering group, an executive office group, a legal group, etc., of the enterprise. In other examples, the group information can identify another type of group, such as a fantasy football group, a sports enthusiast group, a social networking group, and so forth.

The group information can be used by the enterprise AAA server 112 to perform role-based authorization of the electronic device 150, where the role (in the form of the group identified in the group information) of the user is used to determine what resources of the enterprise network 102 are accessible by the electronic device 150.

On the other hand, if the AD 118 does not contain an entry with the mobile number in the lookup request, then the lookup response returned (at 214) to the enterprise AAA server 112 would contain a lookup failed indication to indicate to the enterprise AAA server 112 that the AD 118 does not contain information for the mobile number.

If the lookup response (214) from the AD 118 contains the lookup failed indication that indicates that the mobile number was not found in the AD 118, then the enterprise AAA server 112 can send (at 216) a lookup request containing the mobile number to the guest user repository 116 to determine whether the mobile number is in the guest user repository 116.

In response to the lookup request (216), the guest user repository 116 determines if an entry of the guest user repository 116 contains the mobile number in the lookup request (216). If so, the guest user repository 116 sends (at 218) a lookup response containing an indication that the guest user repository lookup was successful. If the guest user repository 116 determines that no entry of the guest user repository 116 contains the mobile number in the lookup request (216), then the guest user repository 116 sends (at 218) a lookup response containing a lookup failed indication.

In response to the information contained in the lookup response from the AD 118 and/or the guest user repository 116, the enterprise AAA server 112 performs (at 220) policy enforcement based on the information contained in the lookup response. For example, if the AD 118 returned group information for the user of the electronic device 150, the policy enforcement performed at the enterprise AAA server 112 includes a role-based authorization.

As another example, if the AD 118 returned a lookup failed indication but the guest user repository 116 returned a lookup success indication, the enterprise AAA server 112 can authorize the electronic device 150 as a guest (with restricted access of the enterprise network 102).

However, if the responses from the AD 118 and the guest user repository 116 both indicate that lookup has failed (i.e., the mobile number is not in either the AD 118 or the guest user repository 116), the enterprise AAA server 112 can deny the electronic device 150 access of the enterprise network 102.

Based on the policy enforcement performed (at 220), the enterprise AAA server 112 sends (at 222) an authentication response to the NAS 154. The authentication response is a response to the authentication request sent (at 204) by the NAS 154 and can be in the form of an Access-Accept message according to the RADIUS protocol, for example. The authentication response can include role information to identify a role of the user so that the user is granted permissions to access the resources of the enterprise network 102. If the user is a regular user whose information was found in the AD 118, then the role information can identify a role in the enterprise. On the other hand, if the user is a guest whose information was not found in the AD 118 but was found in the guest user repository 116, the role information in the authentication response can indicate that the user is a guest with restricted access of the enterprise network 102.

In examples where the user is a regular user whose information was found in the AD 118, the authentication response may include other information relating to access of resources on the enterprise network 102, including any or some combination of the following, for example: an identifier of a virtual network, such as a virtual local area network (VLAN), that the electronic device 150 can use to access the enterprise network 102, a QoS for the access, and so forth.

In examples where the user is a guest whose information was found in the guest user repository 116, the authentication response may include other information relating to access of resources on the enterprise network 102, including an identifier (e.g., a service set identifier or SSID) of a WLAN that the electronic device 150 is permitted to access, a bandwidth provided to such access by the guest, and so forth.

If information for the user was not found in either the AD 118 or the guest user repository 116, then the authentication response (222) can include an indication that access is denied. For example, in such a case, the authentication response can include an Access-Reject message according to the RADIUS protocol.

Based on the authentication response (222) from the enterprise AAA server 112, the NAS 154 sends (at 224) a response to the electronic device 150, which is in response to the request to connect (202). The response can include information used by the electronic device 150 to access the enterprise network 102, according to permissions provided in the authentication response (222). Alternatively, the response can reject the request to connect from the electronic device 150 if the policy enforcement performed (at 220) by the enterprise AAA server 112 determines that the electronic device 150 is to be denied access.

In some examples, a protection technique can be applied to protect the mobile number (e.g., MSISDN) contained in the authentication response (210) from the service provider AAA server 110 to the enterprise AAA server 112 from unauthorized access, such as by a hacker or other attacker.

In some examples, instead of including the actual mobile number itself in the authentication response, a different value representing the mobile number can be included in the authentication response. For example, the value can include a hash value based on applying a hash function (e.g., a cryptographic hash function such as a Secure Hash Algorithm or SHA function) on the mobile number. In such examples, checking whether the mobile number is present in a user information repository (such as the AD 118 or the guest user repository 116) includes checking whether the hash value in the authentication response matches a hash value stored in the user information repository that includes hash values representing respective different mobile numbers for different users.

In further examples, the value representing the mobile number included in the authentication response includes an encrypted version of the mobile number. In such examples, checking whether the mobile number is present in the user information repository includes decrypting the encrypted version of the mobile number to produce a decrypted mobile number, and determining whether the decrypted mobile number matches any mobile number in the user information repository.

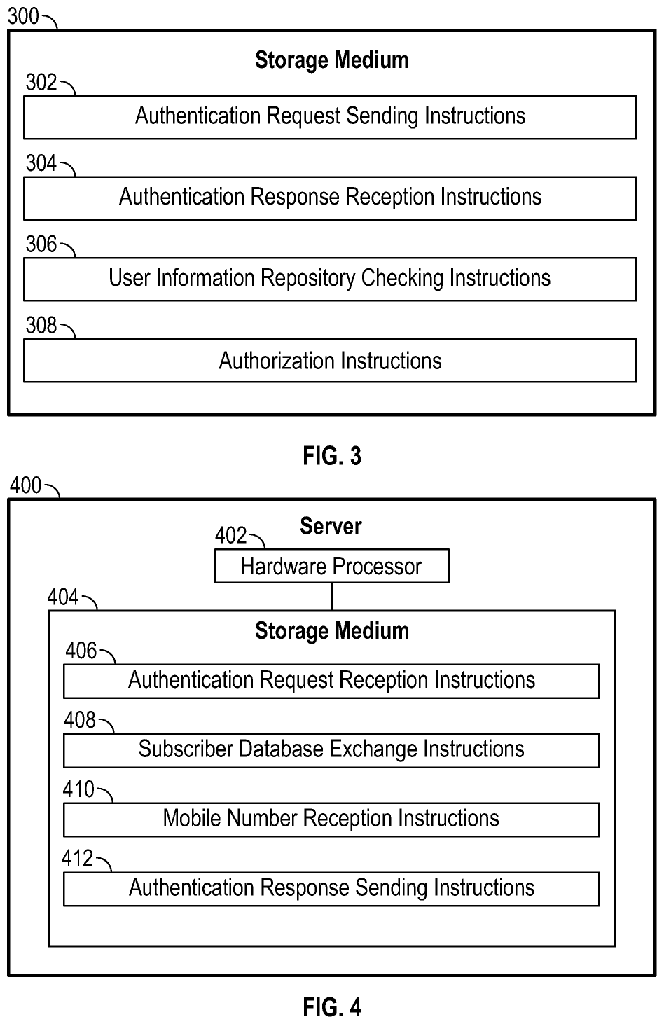

FIG. 3 is a block diagram of a non-transitory machine-readable or computer-readable storage medium 300 storing machine-readable instructions that upon execution cause a system of an enterprise network to perform various tasks. The system may be the enterprise AAA server 112, for example. Alternatively, the system may be another server that is associated with the enterprise network.

The machine-readable instructions include authentication request sending instructions 302 to, in response to a request for authentication transmitted in response to a request by an electronic device to access the enterprise network, send an authentication request from the system to a server that is part of a carrier network. The server that is part of a carrier network can be the service provider AAA server 110, for example.

The machine-readable instructions include authentication response reception instructions 304 to receive, at the system in response to the authentication request, an authentication response that contains a value representing a mobile number for the electronic device. The mobile number can include an MSISDN, for example. The value representing a mobile number in the authentication response can be the mobile number itself, or alternatively, can be a hash value produced by applying a hash function on the mobile number, or an encrypted version of the mobile number.

The machine-readable instructions include user information repository checking instructions 306 to check whether the mobile number represented by the value in the authentication response is present in a user information repository, such as the AD 118 (or more generally an enterprise user repository) and/or the guest user repository 116. The check includes a lookup to find an entry in the user information repository that contains the mobile number. The check can also include other checks, such as determining roles of users, resources on the enterprise network 102 accessible by users, QoS for services accessible by users, and so forth.

The machine-readable instructions include authorization instructions 308 that perform authorization of the electronic device based on the check of whether the mobile number represented by the value in the authentication response is present in the user information repository, the authorization for the electronic device to determine an access permission of the electronic device in the enterprise network.

In some examples, the authorization of the electronic device is performed without performing an onboarding procedure including an assignment of a certificate for the electronic device in the enterprise network.

In some examples, the request for authentication is stored in a SIM in the electronic device.

In some examples, in response to determining that the mobile number represented by the value in the authentication response is not present in the user information repository, the machine-readable instructions deny access of the enterprise network by the electronic device.

In some examples, the storing of the mobile number in the user information repository is responsive to user registration with a provider (e.g., a business concern, a government agency, an educational organization, an individual, etc.) of the enterprise network.

FIG. 4 is a block diagram of a server 400 for a carrier network according to some examples. The server 400 can be the service provider AAA server 110 of FIG. 1, for example.

The server 400 includes a hardware processor 402 (or multiple hardware processors). A hardware processor can include a microprocessor, a core of a multi-core microprocessor, a microcontroller, a programmable integrated circuit, a programmable gate array, or another hardware processing circuit.

The server 400 includes a non-transitory storage medium 404 storing machine-readable instructions executable on the hardware processor 402 to perform various tasks. Machine-readable instructions executable on a hardware processor can refer to the instructions executable on a single hardware processor or the instructions executable on multiple hardware processors.

The machine-readable instructions in the storage medium 404 include authentication request reception instructions 406 to receive, from a second server (e.g., the enterprise AAA server 112) for an enterprise network, an authentication request relating to a request from an electronic device to access the enterprise network, the authentication request containing an identifier from the electronic device. For example, the identifier can be an IMSI from a SIM of the electronic device.

The machine-readable instructions in the storage medium 404 include subscriber database exchange instructions 408 to perform an exchange with a subscriber database to identify whether the subscriber database contains information associated with the identifier. For example, the subscriber database includes the HSS 114 of FIG. 1.

The machine-readable instructions in the storage medium 404 include mobile number reception instructions 410 to receive, from the subscriber database, the information associated with the identifier, the information including a mobile number for the electronic device. The mobile number can include an MSISDN, for example.

The machine-readable instructions in the storage medium 404 include authentication response sending instructions 412 to send, from the server 400 to the second server, an authentication response containing the mobile number that is useable by the second server to identify whether the mobile number is contained in a user information repository for authorizing access of the electronic device to the enterprise network.

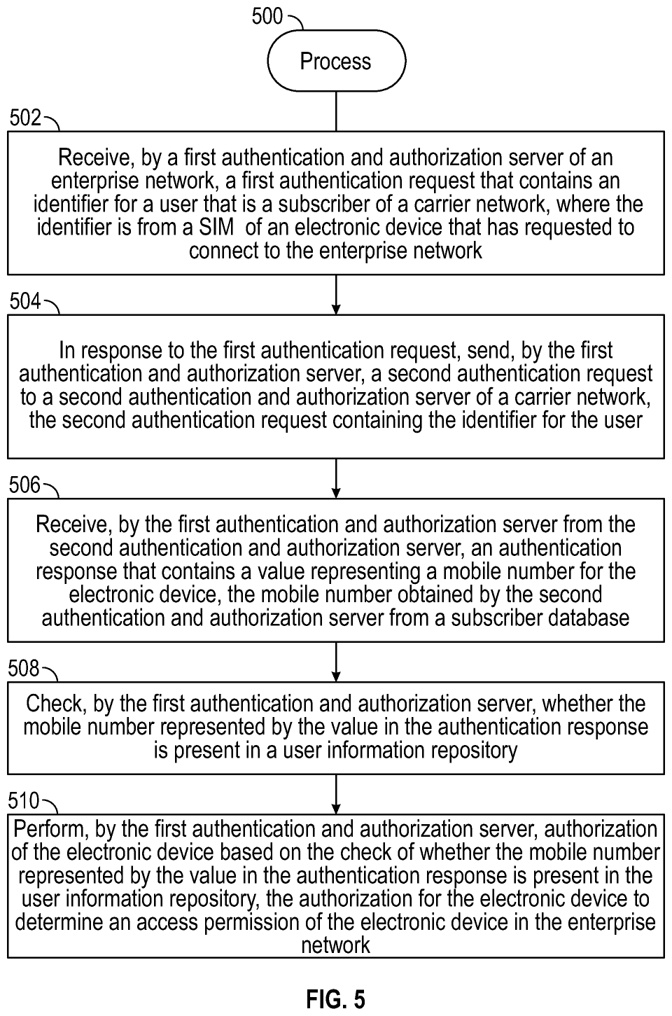

FIG. 5 is a flow diagram of a process 500 according to some examples. The process 500 may be performed by the enterprise AAA server 112, for example, or by another server.

The process 500 includes receiving (at 502), by a first authentication and authorization server of an enterprise network, a first authentication request that contains an identifier for a user that is a subscriber of a carrier network, where the identifier is from a SIM of an electronic device that has requested to connect to the enterprise network. The identifier for the user can be an IMSI, for example.

The process 500 includes, in response to the first authentication request, sending (at 504), by the first authentication and authorization server, a second authentication request to a second authentication and authorization server of a carrier network. The second authentication request contains the identifier for the user. In some examples, the first authentication request is the authentication request sent at 204 in FIG. 2, and the second authentication request is the authentication request sent at 206 in FIG. 2.

The process 500 includes receiving (at 506), by the first authentication and authorization server from the second authentication and authorization server, an authentication response that contains a value representing a mobile number for the electronic device. The mobile number is obtained by the second authentication and authorization server from a subscriber database. The subscriber database can be the HSS 114, for example. The value representing the mobile number can include a hash value or an encrypted version of the mobile number, as explained further above.

The process 500 includes checking (at 508), by the first authentication and authorization server, whether the mobile number represented by the value in the authentication response is present in a user information repository. The user information repository can include the AD 118 and/or the guest user repository 116, for example.

The process 500 includes performing (at 510), by the first authentication and authorization server, authorization of the electronic device based on the check of whether the mobile number represented by the value in the authentication response is present in the user information repository, the authorization for the electronic device to determine an access permission of the electronic device in the enterprise network. The access permission can be a role-based permission for a regular user, or a restricted permission for a guest, as examples.

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

A storage medium (e.g., 300 in FIG. 3 or 404 in FIG. 4) can include any or some combination of the following: a semiconductor memory device such as a dynamic or static random access memory (a DRAM or SRAM), an erasable and programmable read-only memory (EPROM), an electrically erasable and programmable read-only memory (EEPROM) and flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A non-transitory machine-readable storage medium comprising instructions that upon execution cause a system of an enterprise network to:
in response to a request for authentication transmitted in response to a request by an electronic device to access the enterprise network, send an authentication request from the system to a server that is part of a carrier network;
receive, at the system in response to the authentication request, an authentication response that contains a value representing a mobile number for the electronic device;
check whether the mobile number represented by the value in the authentication response is present in a user information repository; and
perform authorization of the electronic device based on the check of whether the mobile number represented by the value in the authentication response is present in the user information repository, the authorization for the electronic device to determine an access permission of the electronic device in the enterprise network.

2. The non-transitory machine-readable storage medium of claim 1, wherein the server that is part of the carrier network comprises an authentication, authorization, and accounting (AAA) server.

3. The non-transitory machine-readable storage medium of claim 1, wherein the mobile number represented by the value in the authentication response comprises a Mobile Station International Subscriber Directory Number (MSISDN).

4. The non-transitory machine-readable storage medium of claim 1, wherein the user information repository comprises an enterprise user repository containing user credentials and permissions of respective users.

5. The non-transitory machine-readable storage medium of claim 1, wherein the user information repository comprises a guest user repository containing information for guests of the enterprise network.

6. The non-transitory machine-readable storage medium of claim 1, wherein the authorization of the electronic device comprises a role-based authorization that assigns permissions in the enterprise network based on user roles.

7. The non-transitory machine-readable storage medium of claim 1, wherein the authorization of the electronic device is performed without performing an onboarding procedure including an assignment of a certificate for the electronic device in the enterprise network.

8. The non-transitory machine-readable storage medium of claim 1, wherein the request for authentication comprises an International Mobile Subscriber Identity (IMSI) stored in a Subscriber Identification Module (SIM) in the electronic device.

9. The non-transitory machine-readable storage medium of claim 1, wherein the instructions upon execution cause the system of the enterprise network to:
in response to determining that the mobile number represented by the value in the authentication response is not present in the user information repository, deny access of the enterprise network by the electronic device.

10. The non-transitory machine-readable storage medium of claim 1, wherein the mobile number is stored in the user information repository responsive to user registration with a provider of the enterprise network.

11. The non-transitory machine-readable storage medium of claim 1, wherein the value representing the mobile number included in the authentication response comprises a hash value based on applying a hash function on the mobile number, and wherein the checking of whether the mobile number represented by the value in the authentication response is present in the user information repository comprises checking whether the hash value in the authentication response matches a hash value stored in the user information repository that includes hash values representing respective different mobile numbers for different users.

12. The non-transitory machine-readable storage medium of claim 1, wherein the value representing the mobile number included in the authentication response comprises an encrypted version of the mobile number, and wherein the checking of whether the mobile number represented by the value in the authentication response is present in the user information repository comprises decrypting the encrypted version of the mobile number to produce a decrypted mobile number, and determining whether the decrypted mobile number matches any mobile number in the user information repository.

13. A first server for a carrier network, comprising:
a processor; and
a non-transitory storage medium comprising instructions executable on the processor to:
receive, from a second server for an enterprise network, an authentication request relating to a request from an electronic device to access the enterprise network, the authentication request containing an identifier from the electronic device;
perform an exchange with a subscriber database to identify whether the subscriber database contains information associated with the identifier;
receive, from the subscriber database, the information associated with the identifier, the information comprising a mobile number for the electronic device; and
send, from the first server to the second server, an authentication response containing the mobile number that is useable by the second server to identify whether the mobile number is contained in a user information repository for authorizing access of the electronic device to the enterprise network.

14. The first server of claim 13, comprising an authentication, authorization, and accounting (AAA) server.

15. The first server of claim 13, wherein the identifier comprises a an International Mobile Subscriber Identity (IMSI).

16. The first server of claim 15, wherein the mobile number comprises a Mobile Station International Subscriber Directory Number (MSISDN).

17. A method comprising:
receiving, by a first authentication and authorization server of an enterprise network, a first authentication request that contains an identifier for a user that is a subscriber of a carrier network, wherein the identifier is from a Subscriber Identity Module (SIM) of an electronic device that has requested to connect to the enterprise network;
in response to the first authentication request, sending, by the first authentication and authorization server, a second authentication request to a second authentication and authorization server of the carrier network, the second authentication request containing the identifier for the user;
receiving, by the first authentication and authorization server from the second authentication and authorization server, an authentication response that contains a value representing a mobile number for the electronic device, the mobile number obtained by the second authentication and authorization server from a subscriber database;
checking, by the first authentication and authorization server, whether the mobile number represented by the value in the authentication response is present in a user information repository; and
performing, by the first authentication and authorization server, authorization of the electronic device based on the check of whether the mobile number represented by the value in the authentication response is present in the user information repository, the authorization for the electronic device to determine an access permission of the electronic device in the enterprise network.

18. The method of claim 17, wherein the checking comprises:
performing a lookup of an enterprise user repository to determine whether the mobile number is present in the enterprise user repository,
wherein the authorization of the electronic device is based on a role of the user in an enterprise in response to a determination that the mobile number is present in the enterprise user repository.

19. The method of claim 18, wherein the checking comprises:
in response to the mobile number not being present in the enterprise user repository, performing a lookup of a guest user repository to determine whether the mobile number is present in the guest user repository,
wherein the authorization of the electronic device is based on a guest status of the user in an enterprise in response to a determination that the mobile number is present in the guest user repository.

20. The method of claim 17, wherein the mobile number comprises a Mobile Station International Subscriber Directory Number (MSISDN).
